(19) United States
(12) Patent Application Publication
(10) Pub. No.: US 2004/0176990 A1
(43) Pub. Date: Sep. 9, 2004

(54) Method and system enabling the trading of a futures contract for the purchase of goods or services

(76) Inventors: Robert C. Vacante, Fort Collins, CO (US); Evan Kirshenbaum, Mountain View, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/378,835

(22) Filed: Mar. 5, 2003

(51) Int. Cl. G06F 17/60

(52) U.S. Cl. 705/10

(57) ABSTRACT

A method and system enabling the trading of a futures contract for the purchase of goods or services. The method includes and the system performs the steps of receiving an offer for a good(s) or service(s) and purchasing a re-sellable future for the good(s) or service(s). The re-sellable future is a contract to purchase a certain quantity of the good(s) or service(s) from a seller at a set price and at an expiration and the re-sellable future may be re-sold. The method may also include and the system may also perform the steps of offering a re-sellable future for a good(s) or service(s) and selling the re-sellable future for the good(s) or service(s).

### CROSS-REFERENCE TO RELATED APPLICATIONS

This application is related to U.S. patent application Ser. No. 10/---,--- (Attorney Docket No. 200207986-1), entitled “METHOD AND SYSTEM FOR EVALUATING PERFORMANCE OF A WEBSITE USING A CUSTOMER SEGMENT AGENT TO INTERACT WITH THE WEBSITE ACCORDING TO A BEHAVIOR MODEL” to Cipriano SANTOS, et al.; U.S. patent application Ser. No. 10/---,--- (Attorney Docket No. 200207987-1), entitled “METHOD AND SYSTEM FOR CUSTOMIZED CONFIGURATION OF AN APPEARANCE OF A WEBSITE FOR A USER” to Evan KIRSHENBAUM, et al.; U.S. patent application Ser. No. 10/---,--- (Attorney Docket No. 200207988-1), entitled “SYSTEM, METHOD AND APPARATUS USING BIOMETRICS TO COMMUNICATE CUSTOMER DISSATISFACTION VIA STRESS LEVEL” to Carol McKENNAN, et al.; U.S. patent application Ser. No. 10/---,--- (Attorney Docket No. 200207991-1), entitled “APPARATUS AND METHOD FOR THEOREM CERTIFICATION WITHOUT DISCLOSING DOCUMENTS THAT LEAD TO THE THEOREM” to Mathias SALLE; U.S. patent application Ser. No. 10/---,--- (Attorney Docket No. 200207993-1), entitled “METHOD AND SYSTEM FOR SELLING AN ITEM OVER A COMPUTER NETWORK” to Evan KIRSHENBAUM, et al.; U.S. patent application Ser. No. 10/---,--- (Attorney Docket No. 200207994-1), entitled “METHOD AND SYSTEM ENABLING THE TRADING OF A RIGHT TO PURCHASE GOODS OR SERVICES” to Robert C. VACANTE, et al., and U.S. patent application Ser. No. 10/---,--- (Attorney Docket No. 200207996-1), entitled “METHOD AND SYSTEM FOR PROCESSING USER FEEDBACK RECEIVED FROM A USER OF A WEBSITE” to Mathias SALLE, et al., all of which are concurrently herewith being filed under separate covers, the subject matters of which are herein incorporated by reference.

### BACKGROUND

In the current world of commerce, a purchaser has limited options for purchasing goods or services. The purchaser identifies a need to purchase a good or service, identifies a seller of such good or service, makes or receives an offer for the good or service, enters into a contract to purchase the good or service, receives the good or service and pays for the good or service. In an ideal world, the purchaser is able to efficiently identify their need for the good or service in advance, enter a contract to establish a price for the good or service, and receive the good or service just in time to satisfy that need.

Unfortunately, too often a purchaser is unable to efficiently identify its need for the good or service. A purchaser frequently enters a contract for a good or service, in order to lock in the price too early, tying up working capital and wasting valuable inventory and storage space. Further, a purchaser's need for the good or service may completely evaporate after entering the contract and prior to receiving the good or service. In this situation, the purchaser must either accept the unwanted good or service or cancel the contract and suffer the consequences (e.g., pay a cancellation fee, loss of goodwill, etc.). On the other hand, if the purchaser waits until its need for the good or service is impending, it runs the risk that prices will increase. Conversely, the seller in this situation runs the risk that prices will decrease or that the purchaser will not buy the good or service.

U.S. Pat. No. 6,418,419 to Nieboer et al. provides an automated system for conditional order transactions. This system does not overcome the problems described above nor provide the flexibility necessary to manage the risks faced by a purchaser. For example, this system does not provide or include the right to trade or resell futures.

### SUMMARY

Embodiments described herein overcome limitations and disadvantages of the prior art. Advantages include enabling purchasers to manage the risks inherent in making purchases of goods and services. In exchange for a small fee (the futures price or fee), purchasers would be able to guarantee prices and postpone final decision-making and associated costs until the future expiration date. The ability to resell the future for a good or service would further mitigate purchaser risk since the purchaser can sell the future if its needs for the product or service change and part or all of the funds invested to obtain the future could be recovered when the future is resold. Sellers are provided with additional flexibility in attracting purchasers and obtaining their business, an ability to guarantee prices and avoid the risk of falling prices, a guarantee that their good or service will be bought, and with additional revenue sources through the sale of futures. Other advantages are apparent from the description below.

These and other advantages are achieved, for example, by a method enabling the trading of a futures contract for the purchase of goods or services. The method includes the steps of receiving an offer for a good(s) or service(s) and purchasing a re-sellable future for the good(s) or service(s). The re-sellable future is a contract to purchase a certain quantity of the good(s) or service(s) from a seller at a set price at a set or contingent expiration.

These and other advantages are also achieved, for example, by a computer-readable medium that includes instructions stored thereon for enabling the trading of a futures contract for the purchase of goods or services. The computer-readable medium includes instructions stored thereon for receiving an offer for a good(s) or service(s) and purchasing a re-sellable future for the good(s) or service(s). These and other advantages are also achieved, for example, by a system enabling the trading of a futures contract for the purchase of goods or services. The system includes a server and a network connecting the server and one or more user machines. The server includes a processor and a computer-readable medium. The computer-readable medium includes instructions stored thereon for receiving an offer for a good(s) or service(s) and purchasing a re-sellable future for the good(s) or service(s).

These and other advantages are also achieved, for example, by a method enabling the trading of a futures contract for the purchase of goods or services. The method includes the steps of offering a re-sellable future for a good(s) or service(s) and selling the re-sellable future for the good(s) or service(s).

### DESCRIPTION OF THE DRAWINGS

The detailed description will refer to the following drawings, wherein like numerals refer to like elements, and wherein:

FIG. 1 is a flowchart illustrating an embodiment of a method for trading of a futures contract for the purchase of goods or services;

FIG. 2 is a flowchart illustrating an alternative embodiment of a method for trading of the futures contract for the purchase of goods or services;

FIG. 3A is block diagram illustrating an embodiment of a system enabling the trading of the futures contract for the purchase of goods or services; and

FIG. 3B is a block diagram illustrating exemplary hardware components of an embodiment a system enabling the trading of the futures contract for the purchase of goods or services.

FIG. 4 is a flowchart illustrating an exemplary utilization of a method for trading of the futures contract for the purchase of goods or services.

### DETAILED DESCRIPTION

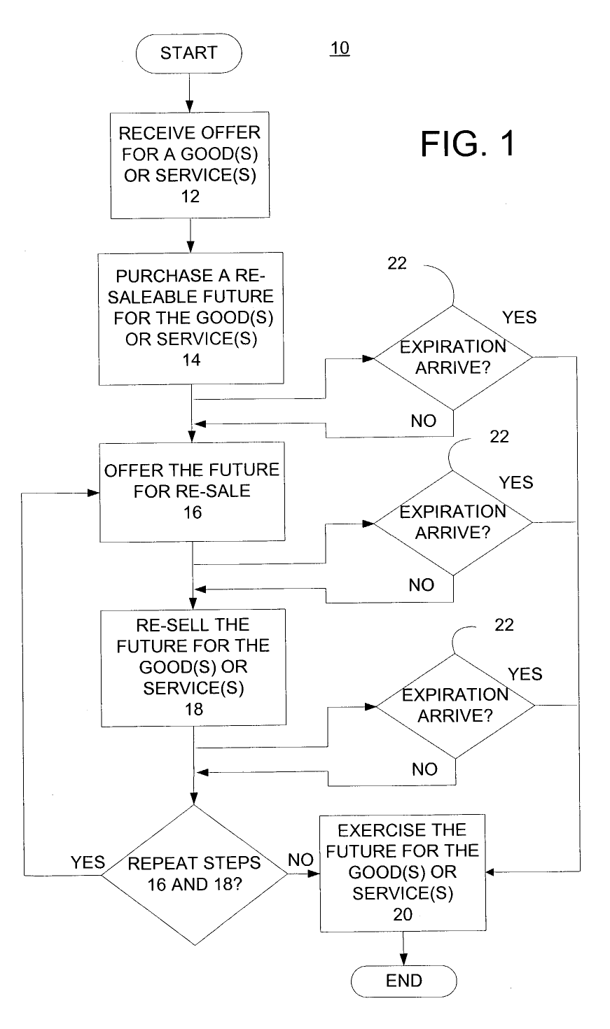

The risks inherent in making purchases of goods and services are managed by a method 10 for trading of a futures contract for the purchase of goods or services, an embodiment of which is illustrated by the flowchart of FIG. 1. The method 10 allows purchasers to secure a price for a good(s) or service(s) while providing the flexibility of being able to postpone final decision-making until the futures expiration since it enables users to purchase, sell and resell a future for a good(s) or service(s), preferably at a price below fair market value for said goods or services. This future for goods or services is analogous to futures for financial vehicles. The future is a contract for the purchase of an agreed upon amount of a certain good(s) or service(s) at an agreed upon price at an agreed upon set or contingent expiration. The future must be exercised at the expiration date and time, which may be a set date and time or a date and time contingent on the occurrence of some event, or on a condition no longer being true or valid, at which point the future must be exercised. In an alternative embodiment or as agreed upon by the principles, the future may be exercised prior to expiration. The future may also specify other standard and non-standard contract terms, such as delivery terms specifying delivery of the good or service within a period of time after the exercise of the future. The future may provides for multiple purchases, each purchase with its own expiration date and time.

As shown in FIG. 1, the embodiment of the method 10 preferably includes the steps of receiving 12 an offer for a good(s) or service(s), purchasing 14 a re-sellable future for the good or service, offering 16 the future for re-sale, reselling 18 the future for the good or service, and exercising 20 the future for the good or service.

As is illustrated, the method 10 preferably determines 22 whether the future's expiration date and time has arrived prior to executing a subsequent step. If the future's expiration date and time has arrived, the exercising step 20 is automatically executed. As noted above, the future expiration date and time may be a set date and time or a date and time triggered by the occurrence of some contingency or by a condition no longer being true or valid. For example, a future expiration date and time may be triggered by the occurrence of an event not fixed in time (e.g., such as a team clinching or being eliminated from a playoff position—useful for “championship logo” merchandise). Therefore, the determining step 22 may include checking to see if the contingency has occurred or if the specified condition is no longer true or valid. Furthermore, in some circumstances the future may be extendable by the future owner paying a fee or satisfying a condition. Therefore, the determining step 22 may also include checking whether the future has been extended and, if not, possibly offering the future owner the opportunity to extend (not shown).

Additionally, the method 10 may include repeating steps 16 and 18, as shown in FIG. 1. Therefore, the method 10 enables multiple re-sales of the future. As mentioned above, the offer of a good(s) or service(s) and the future purchased 14, may be for any quantity of a certain good or service or for any quantities of multiple goods or services. The receiving 12 step is preferably accomplished by viewing the display of the offer in a graphical user interface (GUI) on a display device (not shown, but, described below), but may be accomplished through any known means. The purchasing 14 step is preferably accomplished by inputting an election to purchase through the GUI (e.g., by clicking on a button or other selectable portion of the GUI) and entering requested data, but may be accomplished through any known means (e.g., calling up the seller). Prior to the purchasing 14 step, there may be multiple offers and counter-offers exchanged between the seller and purchaser before an agreement is reached, as with any sale of goods or services.

Once the re-sellable future has been purchased 14, the purchaser may simply hold the future until exercising 20 or offer 16 the future for re-sale. The offering 16 step is preferably accomplished in a manner similar to the receiving 12 step. In other words, an offer to resell the future is preferably transmitted to a user machine (see below) and displayed in a GUI, although the offering 16 step may be accomplished through any known means. Another user, e.g., a third-party purchaser, a futures trader, or the seller, may view the display of the offer in the GUI and decide to purchase the future. The reselling 18 step, therefore, is preferably accomplished by purchaser receiving (e.g., via a network connection) the third-party purchaser's input of an election to purchase the future and any requested data entered by the third-party purchaser. As with the purchasing 14 step above, there may be multiple offers and counter-offers exchanged between the purchaser and the third-party purchaser prior to the parties reaching an agreement in the reselling 18 step. As shown in FIG. 1, the third-party purchaser and subsequent third-party purchasers optionally may repeat the offering 16 and reselling 18 steps until the future is exercised.

Exercising 20 the future involves notifying the original seller that the purchaser or third-party purchasers (the “exercising party”) is exercising the future contract to purchase the good(s) or service(s) and both the seller and the exercising party fulfilling their obligations under the terms of the future. In other words, when the future is exercised 20, the exercising party will receive the agreed-upon good(s) or service(s) and will pay the seller the agreed-upon price for the good(s) or service(s).

As mentioned above, alternatively and/or if the seller and the purchaser agree, the future may be exercised prior to the expiration. Further, such a future may have the ability to be exercised in part or piecemeal, as long as it is completely exercised prior to the expiration date and time. For example, if the future is for 100 widgets, it may be exercised for only 75 widgets on a first date. Likewise, later, if allowed and before the future expires, it may be exercised for 20 widgets, with the future for the remaining 5 widgets purchased before or at the expiration date and time. A future may specify minimum purchase blocks, only allow a single or set amount of purchases, or might require an all-at-once exercise. Likewise, if piecemeal exercise is allowed, the un-exercised portion may be re-sold to third parties or retained. Accordingly, the exercising step 20 may further include determining if the whole future has been exercised and repeating steps 16-22 for the un-exercised portions (not shown).

The seller of the future may want to ensure that the party exercising 20 the future is the rightful owner of the future and has the right to do so. Accordingly, the seller may incorporate security measures when selling the future. For example, the seller may require a verifiable proxy for the future, may include a digital certificate that must accompany the exercise of the future or may require that the purchaser of the future notify the seller of the identity of the third-party purchaser when reselling the future, as described below. The exercising step 20, therefore, may include verifying the proxy, confirming the presence of the authentic digital certificate, verifying the identity of the seller or third-party purchaser, or other similar step.

The verifiable proxy may be created by the seller or purchaser of the future. In one embodiment, the proxy contains minimally information identifying the future and information (such as a public key verified by a trusted 3^{rd} party) that can be used to verify a digital signature of the seller. The proxy is digitally signed by the purchaser, or authorized third-party purchaser, using a private key. If the purchaser re-sells the future, the purchaser must forward the private key to the third-party purchaser. The private key corresponds to a verified public key of the purchaser. Upon receipt of the request to exercise the future, the seller verifies the authenticity of the public key, and then that the future in question is the one mentioned in the proxy. The seller then uses the purchaser's public key to verify that the proxy was in fact signed by the purchaser or authorized third-party purchaser. The seller then uses the public key contained within the proxy, i.e., the seller's information, to verify the seller's digital signature.

Alternatively, a digital certificate that is digitally signed by the seller is delivered to the purchaser with the future. The certificate contains information identifying the future, a verifiable public key associated with the purchaser, and an indication that the rights being shared include the right to create a proxy for the future. The proxy, created and digitally signed by the purchaser or third-party purchaser, contains the certificate (or a reference to it understandable by seller) and information (such as a public key) that can be used to verify a digital signature of the seller. Upon receipt of the notification of the exercise of the future, the seller verifies that the future in question is the one mentioned in the certificate contained in the proxy. The seller then ascertains that the proxy was signed by the owner of the public key contained in the certificate contained in the proxy and that the request was signed by the owner of the public key contained in the proxy.

In still another alternative, security may be ensured by requiring that the purchaser notify the seller when the purchaser wishes to re-sell the future to another entity to exercise the future. Upon receipt of such notification, the seller makes note of that fact.

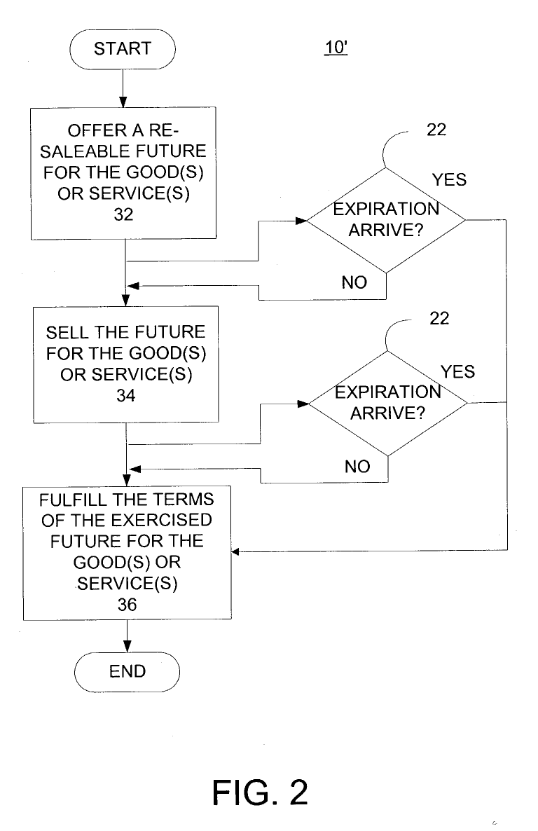

Sellers may also want to offer re-sellable future for sale in order provide their customers greater flexibility and to generate new sources of revenue. FIG. 2 is a flowchart illustrating an embodiment of an alternative method 10′ for trading of a futures contract for the purchase of goods or services. The method 10′ includes the steps of offering 32 a re-sellable future for a good(s) or service(s), selling 34 the future for the good(s) or service(s), and fulfilling 36 the terms of the exercised future. As above, the right to purchase provided by the future may be limited by an expiration date. Therefore, the method 10′ preferably determines 22 whether the future has expired prior to executing a subsequent step, and if the future has expired, the method 10′ ends.

The offering 32 step preferably is accomplished by transmitting an offer of the future to a purchaser's user machine and displaying the offer in a GUI, although the offering 32 step may be accomplished through any known means. The selling 34 step preferably is accomplished by the seller receiving (e.g., via a network connection) the purchaser's input of an election to purchase the future and any requested data entered by the purchaser. As above, there may be multiple offers and counter-offers exchanged between the seller and the purchaser before the parties reach an agreement in the selling 34 step. The purchaser may resell the future to a third-party purchaser. Likewise, the seller may purchase the future back from the purchaser and re-sell the future to a third-party purchaser. Indeed, the seller may repeat this step with the third-party purchaser and subsequent third-party purchasers. Therefore, the fulfilling 36 step is performed with either the purchaser of the future or a third-party purchaser that bought the resold future. The fulfilling 36 step preferably includes the seller receiving a notification (e.g., via a network connection) that the purchaser or third-party purchaser (the “exercising party”) is exercising the future for the good(s) or service(s) and both the seller and the exercising party fulfilling their obligations under the terms of the future. In other words, in performing the fulfilling 36 step, the seller will deliver the agreed upon good(s) or service(s) to the exercising party and will receive payment of agreed-upon amount for the good(s) or service(s). As in the previous example, security measures may optionally be incorporated to verify identities of the seller and purchaser, as well as the seller's authority to resell.

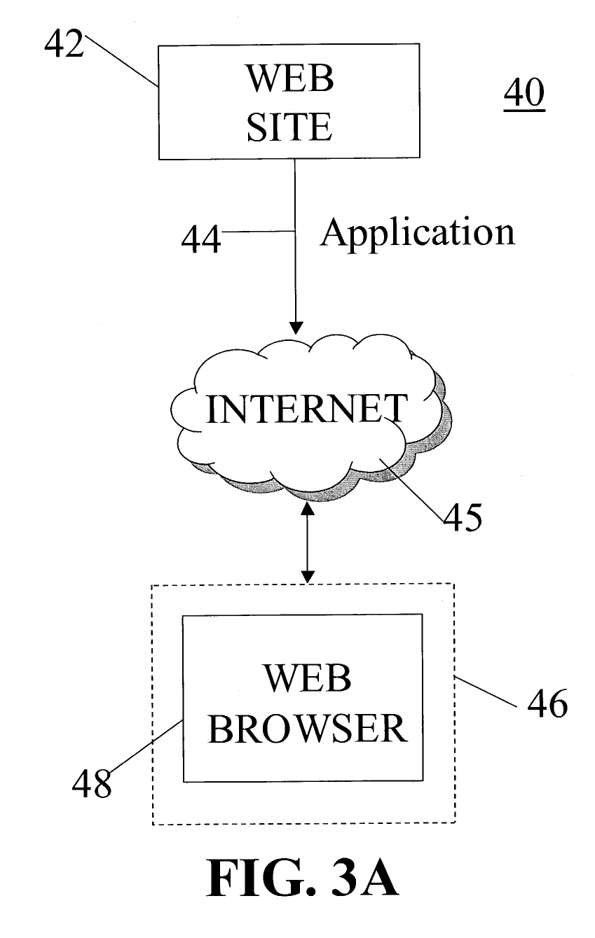

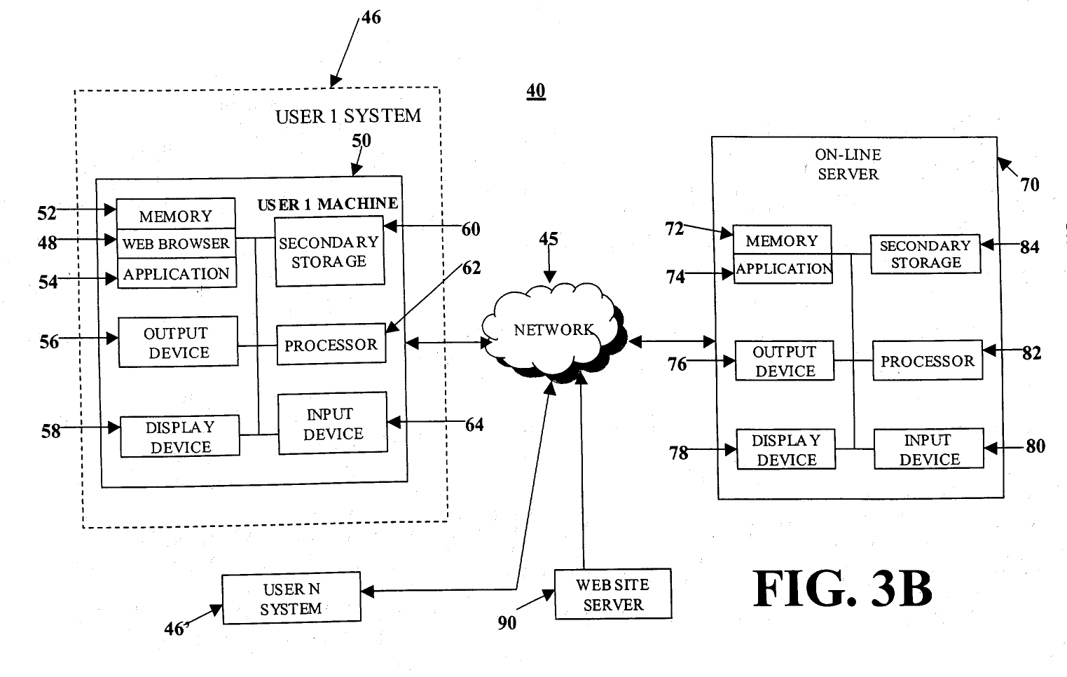

FIG. 3A is a diagram conceptually illustrating operation of an embodiment a system 40 enabling the trading of a futures contract for the purchase of goods or services. The system 40 is preferably used with a web-site 42, which represents one or more applications 44 through which users (e.g., a purchaser, seller or third-party purchaser) can view offers for goods and services, purchase, sell or resell futures for goods or services, and submit offers for selling or reselling futures for goods or services. A user with system 46 may interact with web-site 42 on-line (or otherwise) using a web browser 48 communicating through a network connection such as the Internet 45 or other type of network in order to perform these steps. Optionally (not shown), the system can operate on a peer-to-peer basis between user machines with the necessary applications to perform the methods described above.

FIG. 3B is a block diagram illustrating exemplary hardware components for implementing system 40 enabling the trading of the futures contract for the purchase of goods or services. System 40 includes a user system 46 having a user machine 50 connected with a network 45 such as the Internet, providing a network connection for participating in the trading of futures representing contracts for the purchase of a good(s) or service(s). Other user systems, such as user system 46′ may also be connected with network 45 for other purchasers, sellers or third-party purchasers. User system 46′, and other user systems, may include the same components as user system 46.

Users at user systems 46 and 46′ interact with a server 70 to submit and view offers for goods and services, to purchase, sell or resell futures for goods or services, and to submit and view offers for selling or reselling futures for goods or services. Server 70 provides and maintains the web site 42 for providing a network connection to the application(s) 44 through which users can perform these steps. System 40 may also include the ability to access one or more web site servers 90 in order to obtain content from the World Wide Web, if desired. Only two user systems are shown for illustrative purposes only; system 40 may include many user machines and may be scalable to add or delete user machines to or from the network.

User machine 50 illustrates typical components of a user machine. User machine 50 typically includes a memory 52, a secondary storage device 60, a processor 62, an input device 64, a display device 58, and an output device 56. Memory 40 may include random access memory (RAM) or similar types of memory, and it may store one or more applications 54, and a web browser 48, for execution by processor 62. Secondary storage device 60 may include a hard disk drive, floppy disk drive, CD-ROM drive, or other types of non-volatile data storage. Processor 62 may execute applications or programs 44 or 54 stored in memory 52 or secondary storage 60, or received from the Internet or other network 45, and the processing may be implemented in software, such as software modules, for execution by computers or other machines. These applications 44 or 54 preferably include instructions executable to perform the methods described above and below, with reference to FIGS. 1 and 2 and FIG. 4 below. The applications preferably provide graphical user interfaces (GUIs) through which purchasers and sellers enter information and perform the method steps described above and below. The applications preferably keep track of futures purchased and sold, including the goods and services, the quantity, expiration dates purchase prices, and other data regarding the futures. Input device 64 may include any device for entering information into machine 50, such as a keyboard, mouse, cursor-control device, touch-screen, microphone, digital camera, video recorder or camcorder. The input device 64 may be used to enter information into GUIs during performance of the methods 10 and 10′, as described above. Display device 58 may include any type of device for presenting visual information such as, for example, a computer monitor or flat-screen display. The display device 58 may display the GUIs described above. Output device 56 may include any type of device for presenting a hard copy of information, such as a printer, and other types of output devices include speakers or any device for providing information in audio form.

Web browser 48 is used to access the application(s) 44 through the web site 42 and display various web pages and GUIs through which the user can view offers for goods and services, purchase, sell or resell futures for goods or services, enter necessary data (e.g., description of good or services, quantity, expiration dates, prices, etc) and submit offers for selling or reselling futures for goods or services, and otherwise participate in the trading of futures representing contracts for the purchase of a good(s) or service(s), as describe above. Examples of web browsers include the Netscape Navigator program and the Microsoft Internet Explorer program. Any web browser, co-browser, or other application capable of retrieving content from a network and displaying pages or screens may be used.

Examples of user machines 50 for interacting with the web site 42 include personal computers, laptop computers, notebook computers, palm top computers, network computers, or any processor-controlled device capable of executing a web browser or other type of application for interacting with the system.

Server 70 typically includes a memory 72, a secondary storage device 84, a processor 82, an input device 80, a display device 78, and an output device 76. Memory 72 may include RAM or similar types of memory, and it may store one or more applications 44 for execution by processor 82. Secondary storage device 84 may include a hard disk drive, floppy disk drive, CD-ROM drive, or other types of non-volatile data storage. Processor 82 executes the application(s) 44, which is stored in memory 72 or secondary storage 84, or received from the Internet or other network 45. Input device 80 may include any device for entering information into server 70, such as a keyboard, mouse, cursor-control device, touch-screen, microphone, digital camera, video recorder or camcorder. Display device 78 may include any type of device for presenting visual information such as, for example, a computer monitor or flat-screen display. Output device 76 may include any type of device for presenting a hard copy of information, such as a printer, and other types of output devices include speakers or any device for providing information in audio form.

Server 70 may store a database structure in secondary storage 84, for example, for storing and maintaining information for the trading the futures for goods or services. For example, it may maintain a relational or object-oriented database for storing information concerning outstanding futures (e.g., description of good or service, quantity, price, delivery data, expiration date, etc.), exercised futures, offers for goods or services, offers to sell futures for goods or services or offers to resell futures for goods or services. Using the database structure, the application 44 can track futures, provide necessary information when execution is elected, and determine whether the future has expired (e.g., see step 22 in FIG. 1).

Also, processor 82 may execute one or more software applications 44 in order to provide the functions described in this specification, specifically in the methods 10 and 10′ described above, and the processing may be implemented in software, such as software modules, for execution by computers or other machines. The processing may provide and support web pages and other GUIs described in this specification and otherwise for display on display devices associated with the user machines 50. The term “screen” refers to any visual element or combinations of visual elements for displaying information or forms; examples include, but are not limited to, GUIs on a display device or information displayed in web pages or in windows on a display device. The GUIs may be formatted, for example, as web pages in HyperText Markup Language (HTML), Extensible Markup Language (XML) or in any other suitable form for presentation on a display device depending upon applications used by users to interact with the system 40.

The GUIs preferably include various sections, to provide information or to receive information or commands. The term “section” with respect to GUIs refers to a particular portion of a GUI, possibly including the entire GUI. Sections are selected, for example, to enter information or commands or to retrieve information or access other GUIs. The selection may occur, for example, by using a cursor-control device to “click on” or “double click on” the section; alternatively, sections may be selected by entering a series of key strokes or in other ways such as through voice commands or use of a touch screen or similar apparatus for displaying information and receiving information or commands.

Although only one server 70 is shown, system 40 may use multiple servers as necessary or desired to support the users and may also use back-up or redundant servers to prevent network downtime in the event of a failure of a particular server. In addition, although machine 50 and server 70 are depicted with various components, one skilled in the art will appreciate that these machines and the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as machine 50 and server 70, to perform a particular method, such as method 10 or 10′.

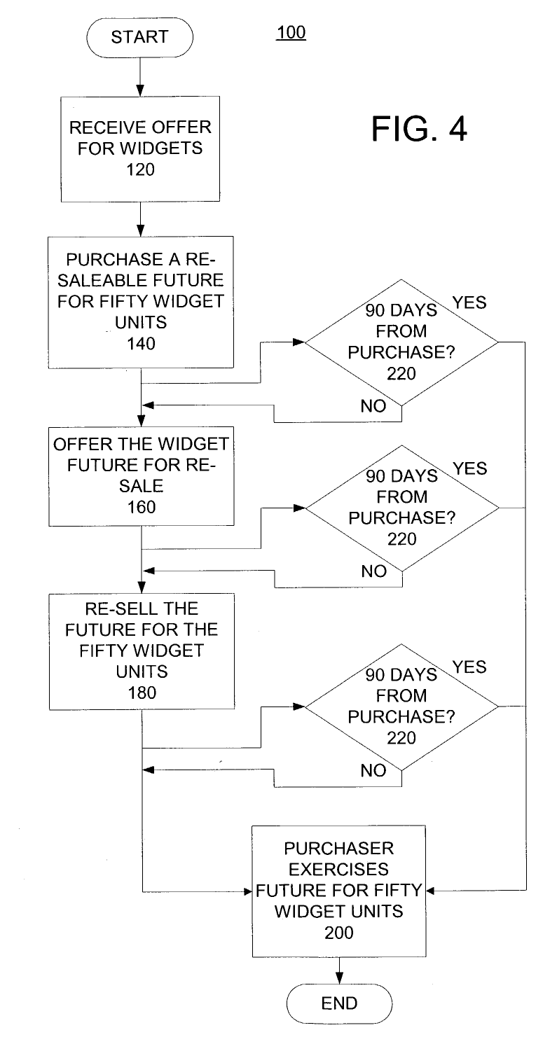

FIG. 4 illustrates an exemplary utilization 100 of the method 10 for re-sellable futures, in this case for widgets. As seen, the utilization 100 comprises a purchaser receiving 120 an offer for widgets from a widgets manufacturer. The offer may be in the form of a listing by the widgets manufacturer on a website or a direct communication (e.g., electronic mail or instant message) to the purchaser. In this example, widgets are a key component of the purchaser's main product. Therefore, it is important to the purchaser to guarantee a price for a future purchase of the widgets. Rather than wait to purchase widgets and risk that the price of widgets could go up, the purchaser wants to purchase a future for widgets. The purchaser, therefore, responds with an offer to the widgets manufacturer to purchase a re-sellable future for fifty units of widgets, at $1000.00 a unit, for $1500.00 with an expiration date and time of close of business (“C.O.B.”) ninety days. The widgets manufacturer may counter with an offer of a re-sellable future for fifty units of widgets, at $1200.00 a unit, for $5000.00 with an expiration date and time of C.O.B. 100 days from purchase. Eventually, the purchaser and manufacturer agree to the purchase 140 of the re-sellable future for fifty units of widgets, at $1100.00 a unit, for $3500.00 with an expiration date and time of C.O.B. 90 days from purchase.

In one example (not shown), the purchaser determines within 80 days of purchase that they need the 50 widget units and eventually exercises 200 the future for the 50 widget units at the expiration date and time. The widget manufacturer delivers the 50 widget units and the purchaser pays $55,000.00 ($1100.00 a unit). For bearing the risk, the widgets manufacturer makes the $3500 futures fee in addition to its normal profit per widget.

In another example, seen in FIG. 4, the demand for the purchaser's main product plummets after the purchase 120 step. Fortunately for the purchaser, the worldwide supply of widgets also plummets due to a mining strike at a mine for the primary material used to make widgets, causing the average price of widgets jumps to $2000.00 a unit. The purchaser offers 160 the widget future for re-sale. At this point, the application 44 checks the database structure in secondary storage 84 and determines 220 that the option has not expired. A third-party purchaser, in this example a second widgets manufacturer that recognizes an opportunity to make a nice profit, offers to purchase the widget future for $10,000.00. After numerous counter-offers, during which time the application 44 checks the expiration date, the purchaser agrees to resell 180 the future for a price of $15,000.00. After the resale 180, the application 44 again checks the expiration date and time and determines that there are five days left until expiration. Accordingly, at the expiration date and time, the second widgets manufacturer exercises 200 the future for the 50 widget units. The first widgets manufacturer delivers the 50 widget units and the purchaser pays $55,000.00. The original purchaser makes a nice profit of $12,500.00 on the future and the third-party purchaser obtains the 50 widget units at $45,000.00 below average market price.

What is claimed is:

1. A method enabling the trading of a futures contract for the purchase of goods or services, comprising the steps of:
receiving an offer for a good(s) or service(s); and
purchasing a re-sellable future for the good(s) or service(s), wherein the re-sellable future is a contract to purchase a certain quantity of the good(s) or service(s) from a seller at a set price and at an expiration and the re-sellable future may be re-sold.

2. The method of claim 1, further comprising the steps of:
offering the re-sellable future for the good(s) or service(s) for re-sale; and
reselling the re-sellable future for the good(s) or service(s), wherein the re-sold future is a contract to purchase a certain quantity of the good(s) or service(s) from the seller at a set price and at an expiration.

3. The method of claim 2, the method further comprising the step of determining whether the expiration has arrived.

4. The method of claim 3, wherein the determining step is performed prior to the reselling step.

5. The method of claim 3, wherein the determining step includes determining whether the future has been extended, and if not, offering an extension.

6. The method of claim 3, further comprising the step of automatically exercising the re-sellable future for the good(s) or service(s) upon determining that the expiration has arrived.

7. The method of claim 1, further comprising the step of exercising the re-sellable future for the good(s) or service(s), wherein the seller delivers the certain quantity of the good(s) or service(s).

8. The method of claim 7, wherein the exercising step further comprises notifying the seller that an owner of the future is exercising the future for the certain quantity of the good(s) or service(s).

9. The method of claim 7, wherein the exercising step further comprises verifying that the owner is authorized to exercise the future.

10. The method of claim 1, wherein the receiving step comprises:
viewing the offer in a graphical user interface (GUI) on a display device.

11. The method of claim 10, wherein the purchasing step comprises:
inputting an election to purchase through the GUI and entering requested data.

12. A computer-readable medium that includes instructions stored thereon for enabling the trading of a futures contract for the purchase of goods or services by:
receiving an offer for a good(s) or service(s); and
purchasing a re-sellable future for the good(s) or service(s), wherein the re-sellable future is a contract to purchase a certain quantity of the good(s) or service(s) from a seller at a set price and at an expiration and the re-sellable future may be re-sold.

13. The computer-readable medium of claim 12 further including instructions stored thereon for:
offering the re-sellable future for the good(s) or service(s) for re-sale; and
reselling the re-sellable future for the good(s) or service(s), wherein the re-sold future is a contract to purchase a certain quantity of the good(s) or service(s) from the seller at a set price and at an expiration.

14. The computer-readable medium of claim 13, wherein the computer-readable medium further includes instructions stored thereon for determining whether the future expiration has arrived.

15. The computer-readable medium of claim 14, wherein the determining step is performed prior to the reselling step.

16. The computer-readable medium of claim 12 further including instructions stored thereon for notifying the seller that an owner of the future is exercising the future for the certain quantity of the good(s) or service(s).

17. The computer-readable medium of claim 12, wherein the instructions for the receiving step further include instructions for viewing the offer in a graphical user interface (GUI) on a display device.

18. The computer-readable medium of claim 17, wherein the instructions for the purchasing step further include instructions for receiving an input election to purchase through the GUI and entered requested data.

19. A system enabling the trading of a futures contract for the purchase of goods or services, the system comprising:
a server, comprising:
a processor;
the computer readable medium of claim 9, wherein the processor executes the instructions stored thereon for enabling the trading of a future for goods or services; and
a network connecting the server and one or more user machines.

20. A method enabling the trading of a futures contract for the purchase of goods or services, comprising the steps of:
offering a re-sellable future for a good(s) or service(s), wherein the re-sellable future is a contract to purchase a certain quantity of the good(s) or service(s) from a seller at a set price and at an expiration and the re-sellable future may be re-sold; and
selling the re-sellable option for the good(s) or service(s).

21. The method of claim 20, further comprising the step of receiving a notification that an owner of the future is exercising the future for the certain quantity of the good(s) or service(s).

22. A computer-readable medium comprising instructions for performing the method of claim 20.
